(19) United States
(12) Patent Application Publication
(10) Pub. No.: US 2010/0117261 A1
(43) Pub. Date: May 13, 2010

(54) Method of making a plastic bench top

(76) Inventors: Richard Bidwell, Union Dale, PA (US); Justin Bidwell, Lenoxville, PA (US); Ryan Bidwell, Union Dale, PA (US)

Correspondence Address: LITMAN LAW OFFICES, LTD., POST OFFICE BOX 41200, SOUTH STATION, ARLINGTON, VA, 22204, US

(21) Appl. No.: 12/289,971

(22) Filed: Nov. 7, 2008

(51) Int. Cl. B29C 53/00

(52) U.S. Cl. 264/239; 264/319

(57) ABSTRACT

The method of making a plastic bench top is a method for manufacturing bench tops having a U-shaped channel formed by flanges depending from opposite sides of an elongated planar member. The bench top is mounted on pedestals, legs or the like. In general, the method includes forming a fold line by machining or by heating along the lateral edges of the elongated planar member to define flanges, folding the flanges so that the flanges are orthogonal to the planar member, and welding or fusing the joint, if necessary. Alternatively, discrete flange members may be heated simultaneously with the elongated lateral edges of the planar member, the heating element is withdrawn from between the flange and the planar member, and the flange is butted against the longitudinal edge to form a butt weld.

### BACKGROUND OF THE INVENTION

1. Field of the Invention

The present invention relates to plastic manufacturing processes, and particularly to a method of making a plastic bench top that uses less material while preserving strength and rigidity.

2. Description of the Related Art

Elongated plastic benches, which are typically formed from high density polyethylene and other plastics, are commonly found in locker rooms and the like. The bench tops for such benches are typically formed from elongated plastic members having thicknesses of between approximately 1⅜ inches and 1½ inches by extrusion or molding processes. This thickness provides a bench top having sufficient rigidity and structural stability for usage in a high volume area, such as a locker room.

Benches formed from plastic having such thicknesses, however, are difficult and costly to manufacture and, due to their volumes, costly to ship. It would be desirable to provide a plastic bench top having the same high level of rigidity and structural stability, but being formed from a plastic having a thickness of less than one inch, allowing for ease of manufacturing, in terms of labor and cost, and ease in shipping.

Thus, a method of making a plastic bench top solving the aforementioned problems is desired.

### SUMMARY OF THE INVENTION

The method of making a plastic bench top is a method for manufacturing bench tops having a U-shaped channel formed by flanges depending from opposite sides of an elongated planar member. The bench top is mounted on pedestals, legs or the like. In general, the method includes forming a fold line by machining or by heating along the lateral edges of the elongated planar member to define flanges, folding the flanges so that the flanges are orthogonal to the planar member, and welding or fusing the joint, if necessary. Alternatively, discrete flange members may be heated simultaneously with the elongated lateral edges of the planar member, the heating element is withdrawn from between the flange and the planar member, and the flange is butted against the longitudinal edge to form a butt weld.

Three different methods may be used to form the fold line. In one method, V-shaped grooves are machined in the planar member. The flanges are folded to mate the diagonal sides of the groove, the joint being made permanent by a fillet weld. In a second method, arcuate or cylindrical heating elements are placed on opposite sides of the planar member to soften the plastic, which is then folded in radius bends to form the channel. In a third method, V-shaped heating elements are used to form V-shaped grooves in the planar member on opposite elongated sides to form the flanges, which are than folded orthogonal to the planar member and fused together to form the channel.

These and other features of the present invention will become readily apparent upon further review of the following specification and drawings.

### BRIEF DESCRIPTION OF THE DRAWINGS

FIG. 1 is an exploded view of a bench including a bench top formed from the method of making a plastic bench top according to the present invention.

FIGS. 2A and 2B are perspective views illustrating a first embodiment of the method of making a plastic bench top according to the present invention.

FIGS. 3A and 3B are end views illustrating the method of FIGS. 2A and 2B.

FIGS. 4A and 4B are end views illustrating an alternative embodiment of the method of making a plastic bench top according to the present invention.

FIGS. 5A and 5B are side views illustrating another alternative embodiment of the method of making a plastic bench top according to the present invention.

FIGS. 6A and 6B are side views illustrating yet another alternative embodiment of the method of making a plastic bench top according to the present invention.

Similar reference characters denote corresponding features consistently throughout the attached drawings.

### DETAILED DESCRIPTION OF THE PREFERRED EMBODIMENTS

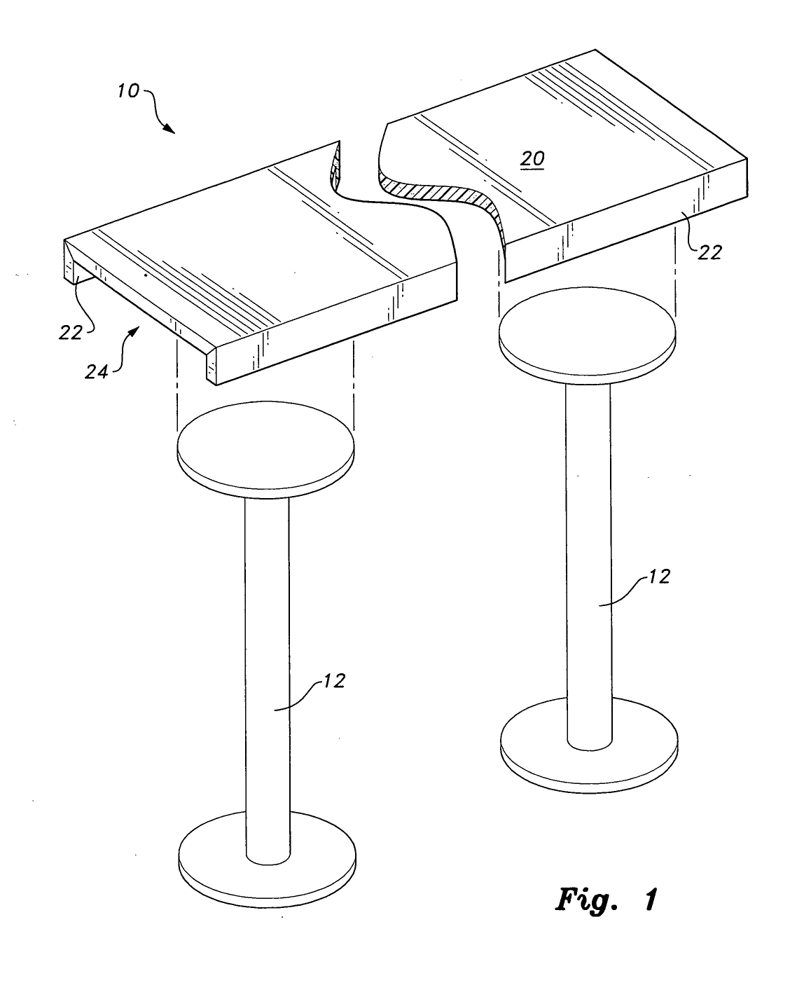

The present invention provides a method for making plastic bench tops for benches, such as the exemplary bench illustrated in FIG. 1. As shown, the exemplary bench includes a plastic bench top 10 having a U-shaped channel 24. The bench top 10 may be mounted on pedestals 12, legs or the like. It should be understood that the bench top 10 is shown for exemplary purposes only, and may have any desired dimensions, color, etc. Such elongated, plastic bench tops 10 are often used in locker rooms and the like, where durable and water-resistant benches are desired.

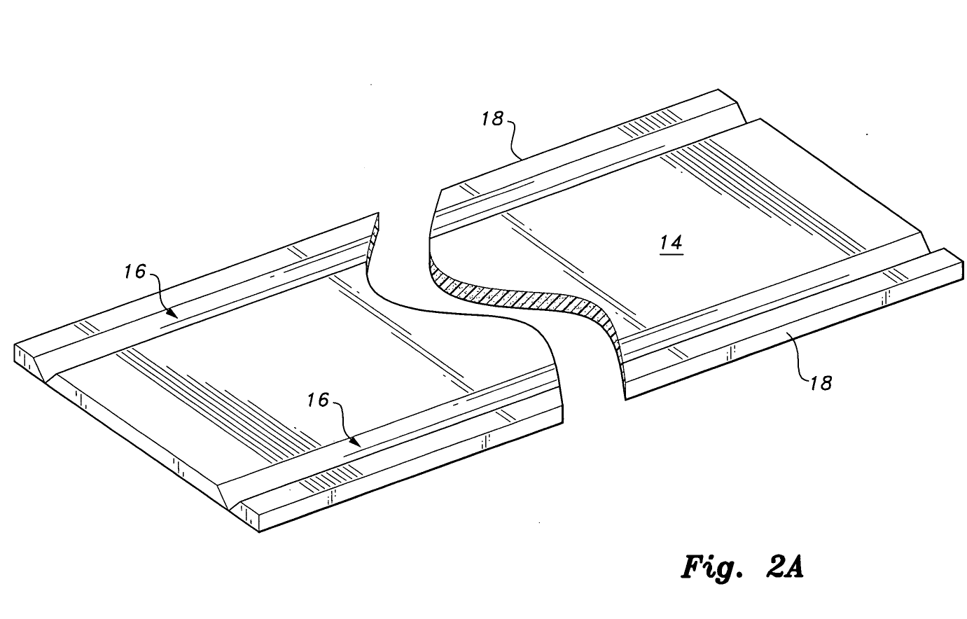

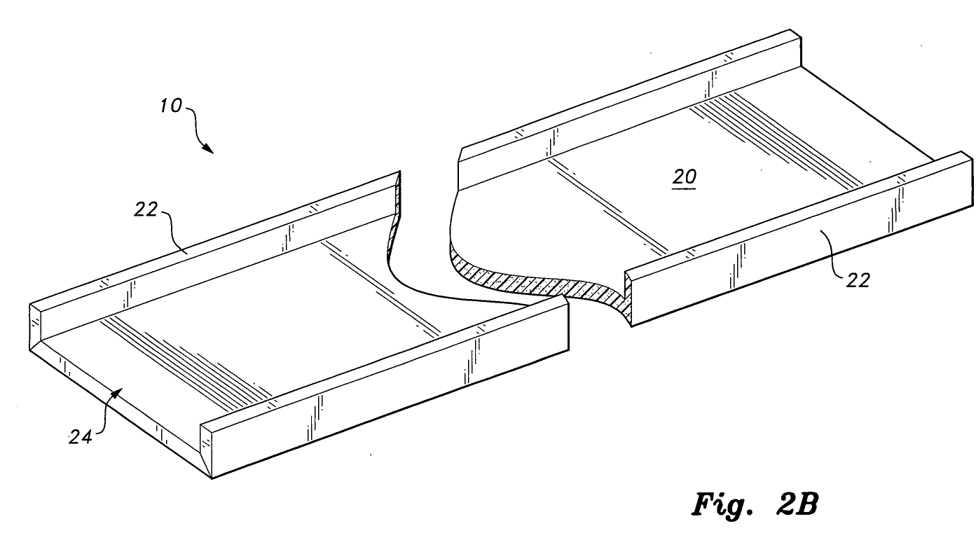

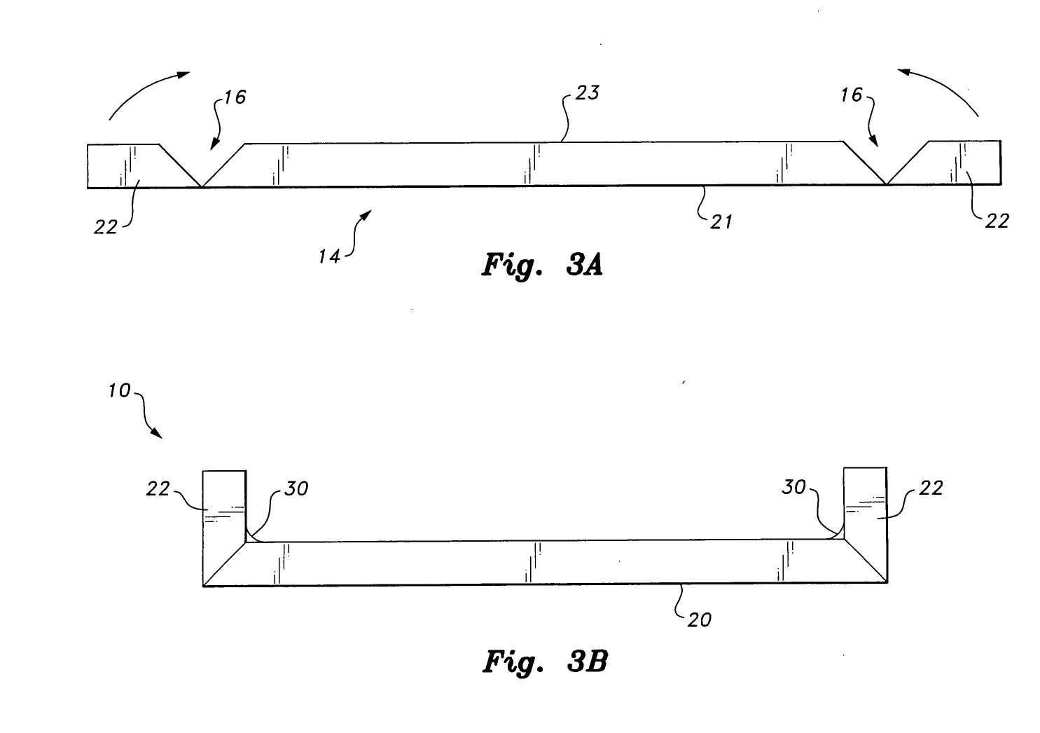

As best shown in FIGS. 2A and 3A, the method involves forming the bench top 10 from an elongated, planar plastic member 14 having a pair of laterally opposed, longitudinally extending side edges 18, a top surface 21 and a bottom surface 23. A pair of longitudinally extending V-shaped grooves 16 are then formed in the bottom surface 23 thereof, e.g., by machining the plastic with a cutting tool. The pair of longitudinally extending V-shaped grooves 16 divide the elongated plastic member 14 into a central portion 20 and a pair of laterally opposed flanges 22. The pair of longitudinally extending V-shaped grooves 16 may be cut, drilled or otherwise machine formed or removed from the bottom surface of the elongated plastic member 14. Alternatively, the V-shaped grooves 16 may be formed during the molding process of forming the elongated plastic member 14. Exemplary dimensions include a thickness of between approximately ½ inches and one inch. Elongated plastic member 14 may be formed from any suitable type of plastic, such as, for example, high density polyethylene (HDPE).

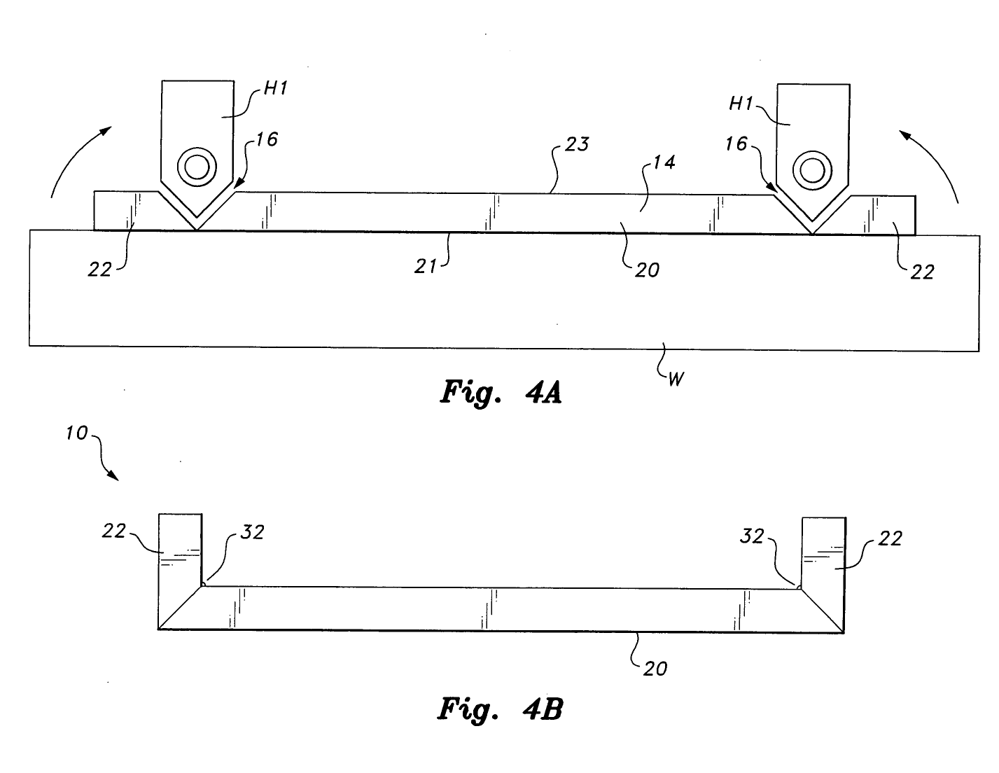

Alternatively, as illustrated in FIG. 4A, the pair of longitudinally extending V-shaped grooves 16 may be formed by melting the bottom surface 23 of the elongated plastic member 14 through the application of heat thereto by an external heat source, such as a pair of longitudinally extending V-shaped heating elements H1. It should be understood that V-shaped grooves 16 may be formed via any suitable method.

The flanges 22 are then folded about the pair of longitudinally extending V-shaped grooves 16 so that opposing faces of the V-shaped groove 16 bear against each other and the pair of laterally opposed flanges extend substantially orthogonal to the central portion 20, forming the U-shaped channel 24 on the bottom side of the plastic bench top 10. When the pair of longitudinally extending V-shaped grooves 16 are cut, drilled or otherwise machine formed or removed from the bottom surface 23 of the elongated plastic member 14, as in FIGS. 2A, 2B, 3A and 3B, the pair of side portions 22 may be fillet welded or fused to the central portion 20 to secure the flanges 22 in place. The fillet welds from this welding process are designated generally as 30 in FIG. 3B.

When the pair of longitudinally extending V-shaped grooves 16 are melted into the bottom surface 23 of the elongated plastic member 14, as in FIG. 4A, the initial melting removes the need for additional welding to secure the flanges 22 in place, as opposing faces of the V-shaped groove 16 fuse together. Once cooled, the flanges 22 are fixed in place with respect to the central portion 20. The seams from the fused joint are designated generally as 32 in FIG. 4B.

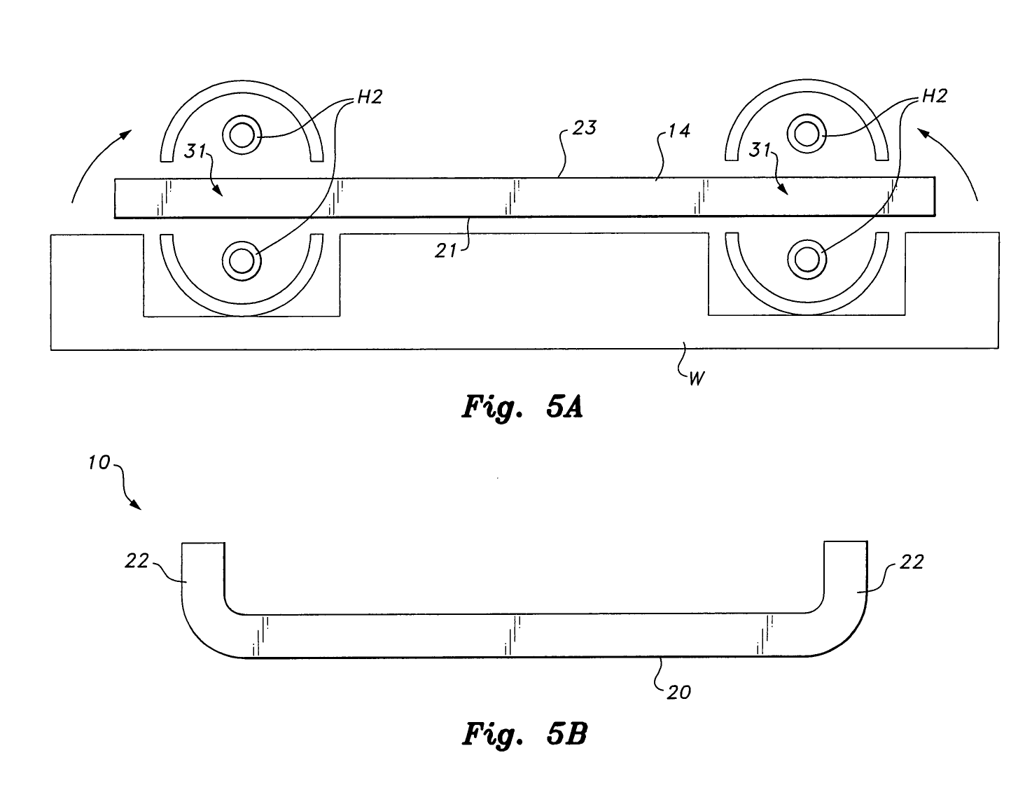

In the alternative embodiment of FIGS. 5A and 5B, the method includes, as in the previous embodiment, first providing an elongated planar plastic member 14 having a pair of laterally opposed, longitudinally extending side edges 18, a top surface 21 and a bottom surface 23. As shown in FIG. 5A, a work surface W is further provided, with top surface 21 resting on the work surface W. Heat is next applied to at least the bottom surface 23 of the elongated plastic member 14 to form a pair of longitudinally extending melted regions 31, which divide the elongated plastic member 14 into the central portion 20 and the pair of flanges 22. As shown in FIG. 5A, the work surface W may include recesses to hold additional heating elements H2, so that heat is applied by heating elements H2 to the bottom surface 23 and well as the top surface 21. The flanges 22 are then folded about the pair of longitudinally extending melted regions 31 so that the flanges extend substantially orthogonal to the central portion 20 to form the bench top 10. The heating elements are arcuate or cylindrical in order to form radius bends defining the flanges 22.

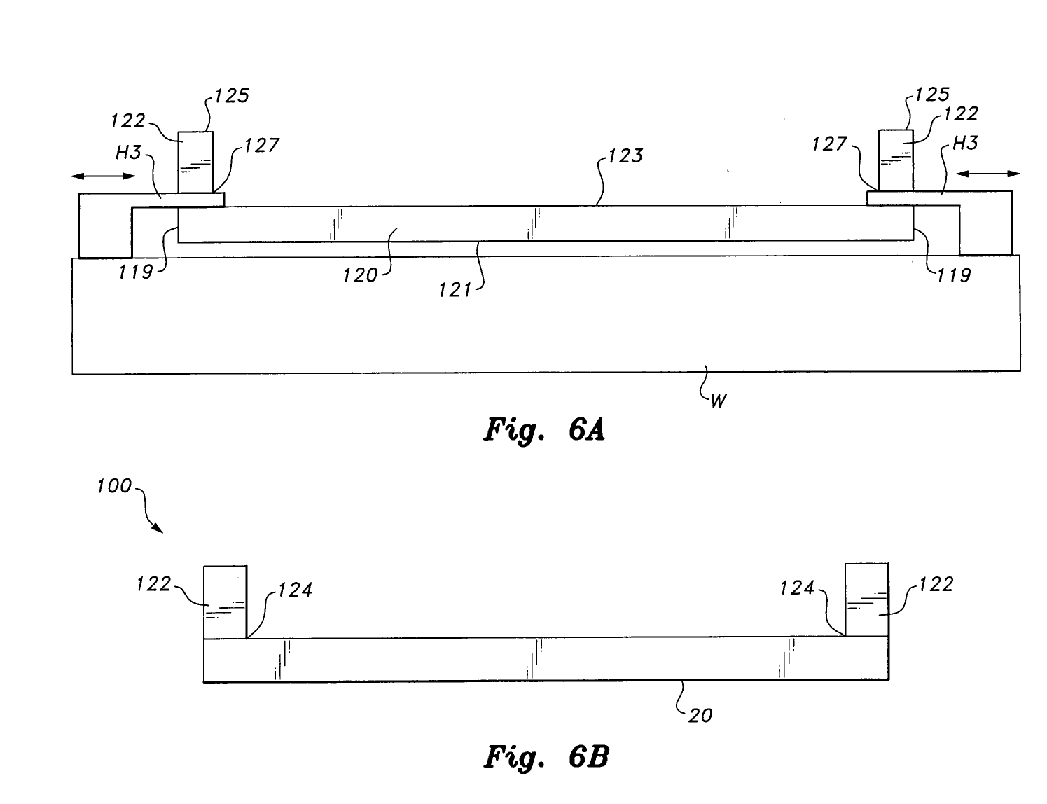

As a further alternative embodiment, illustrated in FIGS. 6A and 6B, an elongated planar plastic member 120 having a pair of laterally opposed, longitudinally extending side edges 119, a top surface 121 and a bottom surface 123 is provided, as in the previous embodiments, as well as a pair of longitudinally extending leg members 122, each having opposed top and bottom surfaces 127, 125, respectively. Heat is then applied from an external heat source, such as the pair of heating elements H3, to the bottom surface 123 of the elongated plastic member 120 adjacent the laterally opposed, longitudinally extending side edges 119 thereof, and the heat is further simultaneously applied to the top surfaces 127 of the pair of longitudinally extending leg members 122 by placing heating elements H3 between the planar member 120 and the leg members 122. The heating elements H3 are then removed, and the heated top surfaces 127 of the pair of longitudinally extending leg members 122 are butt welded to the heated bottom surface 123 of the elongated plastic member 120 to form the plastic bench top 100, the leg members 122 defining the channel flanges. The seams from this butt welding process are designated generally as 124 in FIG. 6B. Preferably, as shown in FIG. 6A, the heating elements H3 are movably mounted with respect to work surface W. Thus, after melting, the heating elements H3 may be slid to the sides, allowing the leg members 122 to drop and be positioned on the melted bottom surface 123.

It is to be understood that the present invention is not limited to the embodiments described above, but encompasses any and all embodiments within the scope of the following claims.

1. A method of making a plastic bench top, comprising the steps of:
providing an elongated planar plastic panel having a pair of laterally opposed, longitudinally extending side edges, a top surface and a bottom surface, the panel having a thickness of between approximately one-half inch and one inch;
forming fold lines along opposite sides of the elongated, planar plastic panel to define a central bench top area and opposing elongated flanges on opposites sides of the central bench top area; and
folding the flanges to bear against each other and extend substantially normal to the central bench top area, defining a channel-shaped bench top.

2. The method of making a plastic bench top according to claim 1, wherein said step of forming fold lines further comprises forming a pair of longitudinally extending V-shaped grooves.

3. The method of making a plastic bench top as recited in claim 2, wherein said step of forming V-shaped grooves comprises machining the V-shaped grooves in the plastic panel with a culling tool.

4. The method of making a plastic bench top as recited in claim 3, further comprising the step of forming a fillet weld between the flanges and the central bench top area in order to rigidly fix the flanges to form the channel-shaped bench top.

5. The method of making a plastic bench top as recited in claim 2, wherein said step of forming V-shaped grooves comprises heating the elongated plastic panel with a V-shaped heating element, opposite sides of said V-shaped groove being fused together when said flanges are folded substantially orthogonal to the central bench top area in order to rigidly fix said flanges to define the channel-shaped bench top.

6. The method of making a plastic bench top according to claim 1, wherein said step of forming fold lines comprises heating the plastic panel with cylindrical heating elements, said step of folding the flanges comprising forming radius bends in the plastic panel to define the flanges.

7. The method of making a plastic bench top according to claim 1, wherein said step of forming fold lines comprises heating the plastic panel with arcuate heating elements, said step of folding the flanges comprising forming radius bends in the plastic panel to define the flanges.

8. The method of making a plastic bench top according to claim 1, wherein said step of folding the flanges comprises forming radius bends along the fold lines in the plastic panel to define the flanges.

9. A method of making a plastic bench top, comprising the steps of:
providing an elongated plastic member having a pair of laterally opposed, longitudinally extending side edges, a top surface and a bottom surface, the member having a thickness of between approximately one-half inch and one inch;
applying heat to the bottom surface of said elongated plastic member to form a pair of longitudinally extending melted regions dividing said elongated plastic member into a central portion and a pair of laterally opposed side portions; and
folding the pair of laterally opposed side portions about the pair of longitudinally extending melted regions so that the pair of laterally opposed side portions bear against each other and extend substantially orthogonal to the central portion.

10. The method of making a plastic bench top as recited in claim 9, further comprising the step of applying heat to the top surface of said elongated plastic member to form the pair of longitudinally extending melted regions.

11. A method of making a plastic bench top, comprising the steps of:
placing a heating element between sides of an elongated planar plastic panel and elongated legs extending along the sides of the plastic panel;
applying heat to the heating element;
removing the heating element from between the plastic panel and the leg members; and
butting the leg members against the plastic panel to butt weld the leg members to the panel, the leg members defining channel flanges.

12. The method of making a plastic bench top according to claim 1, wherein the plastic is a high density polyethylene (HDPE).
